(19) United States
(12) Patent Application Publication
(10) Pub. No.: US 2025/0340496 A1
(43) Pub. Date: Nov. 6, 2025

(54) SOLID PROPELLANT COMPOSITION FOR CURING AZIDE-ALKYNE TRIAZOLE AND METHOD FOR PREPARING SOLID PROPELLANT USING SAME

(71) Applicant: AGENCY FOR DEFENSE DEVELOPMENT, Daejeon (KR)

(72) Inventors: Byoung Sun MIN, Daejeon (KR); Sung June KIM, Daejeon (KR); Hong Min SHIM, Daejeon (KR); Heun Jong HA, Daejeon (KR)

(73) Assignee: AGENCY FOR DEFENSE DEVELOPMENT, Daejeon (KR)

(21) Appl. No.: 18/676,714

(22) Filed: May 29, 2024

(30) Foreign Application Priority Data
May 2, 2024 (KR) 10-2024-0058653

(51) Int. Cl. C06B 45/10; C06B 43/00; C08G 73/08

(52) U.S. Cl. CPC C06B 45/105; C06B 43/00; C08G 73/08

(57) ABSTRACT

The present disclosure relates to a solid propellant composition for curing azide-alkyne triazole, which cures a propellant by forming a polymer network using triazole groups formed by a reaction between an azide compound and an alkyne compound, and a method for preparing a solid propellant using same.

### CROSS-REFERENCE TO RELATED APPLICATIONS

This application claims the priority of Korean Patent Application No. 10-2024-0058653 filed on May 2, 2024, in the Korean Intellectual Property Office, the disclosure of which is incorporated herein by reference.

### BACKGROUND OF THE INVENTION

### Field of the Invention

The present disclosure relates to a composition of a mixed solid propellant and a method for preparing a solid propellant using same and, more particularly, to a solid propellant composition for curing a propellant with a triazole group and a method for preparing a mixed solid propellant using same.

### Description of the Related Art

A mixed solid propellant is prepared by mixing a liquid binder and solid particles in a certain ratio, adding a curing agent thereto, and curing the mixture for a certain time or period. Such a conventional solid propellant has been prepared by using a urethane curing system to form a polymer network by urethane groups formed by a reaction of a hydroxyl-terminated polymer and an isocyanate compound in a binder.

The urethane curing system, which has been applied to mixed solid propellants for decades, must always be equipped with a separate dehumidifying device to block moisture during and after preparing a propellant due to the sensitivity of the isocyanate curing agent to moisture, which causes an increase in the incidental costs required to prepare propellants. In addition, after a certain period of time after exposure to moisture during use, a multifunctional isocyanate compound has a decreased isocyanate functional index and solidifies, resulting in a decrease in the quality of the propellant and causing premature disposal of the isocyanate compound. In addition, in order to solve the above-described problems, dehumidification is essential for preparing propellants, which may increase the risk of propellants due to static electricity, especially in winter.

Recently, compatibility problems with ammonium diniramide (hereinafter referred to as ADN), a high-energy oxidizing agent of an isocyanate curing agent, have arisen, becoming a major obstacle to increasing the specific impulse of propellants. In addition, because toxic gases such as phosgene are used in the synthesis of isocyanate curing agents, there are recent major restrictions on the synthesis of isocyanate curing agents in developed countries. In addition, isocyanate curing agents also have process complexity in that the type and content of acid or base catalyst must be different depending on the type of isocyanate curing agent during urethane reaction.

Accordingly, in order to overcome the problems of the conventional urethane curing system, the present inventors, the inventions of the present disclosure have developed a solid propellant composition for curing azide-alkyne triazole, which cures a propellant by forming a polymer network using triazole groups formed by a reaction between an azide compound and an alkyne compound, and a method for preparing a solid propellant using same, and confirmed the properties of the solid propellant prepared by such method, and has completed the present disclosure.

### SUMMARY OF THE INVENTION

An objective of the present disclosure is to provide a solid propellant composition having excellent performance, and a method for preparing a solid propellant using same, while introducing a curing system that replaces the conventional urethane curing system that has the above-described problems.

In addition, another objective of the present disclosure is to provide a solid propellant composition comprising a curing agent having a low sensitivity to moisture, and a method for preparing a solid propellant using same.

In addition, another objective of the present disclosure is to provide a method for preparing a solid propellant composition comprising a curing agent with excellent compatibility with ammonium diniramide (ADN), which is a high-energy oxidizing agent, and a method for preparing a solid propellant using same.

The objectives of the present disclosure are not limited to the objects described above and other objectives will be clearly understood by those skilled in the art from the following description.

In order to achieve the above-described objectives, there is provided a solid propellant composition for curing azide-alkyne triazole, comprising a polymer having alkyne groups or azide groups at both ends and a compound having azide groups or alkyne groups at two or three ends as a curing agent, wherein the alkyne groups of the polymer react with the compound having azide groups to form a triazole group, and the azide groups of the polymer react with the compound having alkyne groups to form a triazole group.

In addition, there is provided a solid propellant composition for curing azide-alkyne triazole, characterized in that the composition comprises a polymer having alkyne groups at both ends and a compound having azide groups at the ends as a curing agent, and the compound having azide groups at the ends is a mixture of a compound represented by the following formula 5 and a compound represented by the following formula 6:

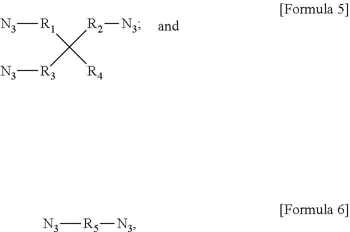

wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

In addition, there is provided a solid propellant composition for curing azide-alkyne triazole, comprising a polymer having azide groups at both ends and a compound having alkyne groups at the ends as a curing agent.

The compound having alkyne groups at the ends may be any one or a mixture of two or more selected from compounds represented by the following formulae 1 to 3:

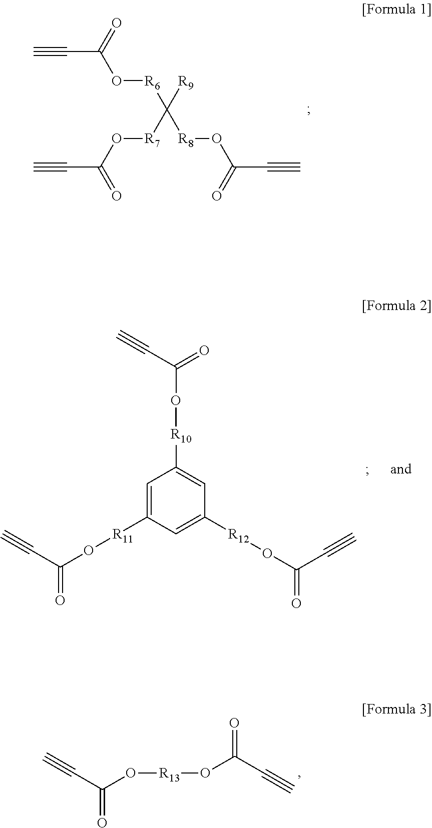

wherein R₆ to R₈, and R₁₀ to R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₉ is an alkyl group having 1 to 20 carbon atoms.

In addition, there is provided a solid propellant composition for curing azide-alkyne triazole, comprising a polymer having azide groups at both ends, a compound represented by the following formula 5 having azide groups at the ends as a crosslinking agent, and a compound represented by the following formula 3 having alkyne groups at the ends as a curing agent:

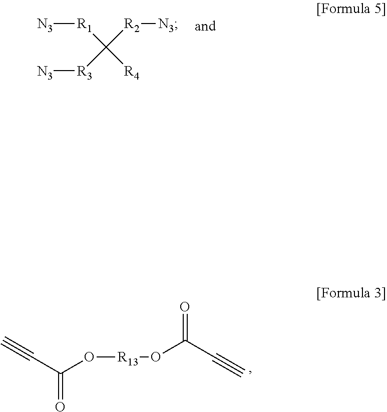

wherein R₁ to R₃ and R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The polymer having alkyne groups at both ends may be represented by the following formula a:

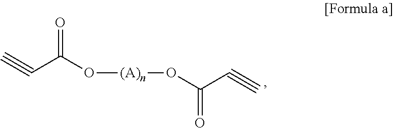

wherein A is an alkylene group having 1 to 20 carbon atoms or an alkenylene group having 2 to 20 carbon atoms, and n is a positive integer.

The polymer having alkyne groups at both ends may be one in which the hydroxyl groups at both ends are substituted with alkyne groups by reacting a polymer having hydroxyl groups at both ends with a compound having a propiolate group at one end and an isocyanate group at the other end.

The polymer having azide groups at both ends may be one or a mixture of two or more selected from compounds represented by the following formulae b, c and d:

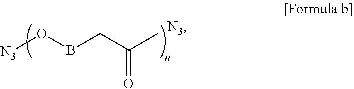

wherein B is an alkylene group having 1 to 20 carbon atoms or an alkenylene group having 2 to 20 carbon atoms, and n is a positive integer;

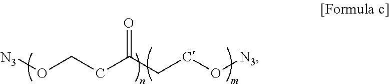

wherein C and C′ are each independently an alkylene group having 1 to 20 carbon atoms or an alkenylene group having 2 to 20 carbon atoms, and m and n are positive integers; and

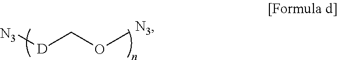

wherein D is an alkylene group having 1 to 20 carbon atoms or an alkenylene group having 2 to 20 carbon atoms, and n is a positive integer.
wherein D is an alkylene group having 1 to 20 carbon atoms or an alkenylene group having 2 to 20 carbon atoms, and n is a positive integer.

The polymer having azide groups at both ends may be one or a mixture of two or more selected from the group consisting of polycaprolactone, polyethylene glycol, and polycaprolactone ether whose both ends are substituted into azide groups.

The solid propellant composition may comprise, as an oxidizing agent, ammonium perchlorate (AP) alone or mixed with any one or a combination of two or more selected from the group consisting of ammonium diniramide (ADN), cyclotrimethylene trinitramine (RDX), cyclotetramethylene tetranitramine (HMX) and hexanitro-hexaaza-tetracyclododecane (HNIW).

The solid propellant composition may comprise aluminium (Al) as a metal fuel.

The solid propellant composition may comprise any one or a combination of two or more selected from the group consisting of Isodecyl pelargonate (IDP), butyl nitroethyl nitramine (BuNENA), butanetriol trinitate (BTTN) and trimethylol trinitrate (TMETN) as a plasticizer.

The solid propellant composition may comprise, as a binder, a compound represented by the following formula 7:

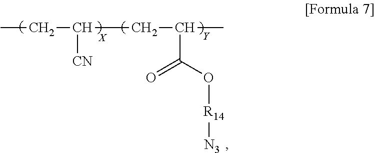

wherein R₁₄ is an alkylene group having 1 to 10 carbon atoms or an alkenylene group having 2 to 10 carbon atoms, Y is a positive number, and X is 1Y to 5Y.

In addition, there is provided a method for preparing a solid propellant for curing azide-alkyne triazole, comprising mixing a polymer having alkyne groups or azide groups at both ends and a compound having azide groups or alkyne groups at two or three ends as a curing agent, followed by curing, wherein the alkyne groups of the polymer react with the compound having azide groups to form a triazole group, and the azide groups of the polymer react with the compound having alkyne groups to form a triazole group.

In addition, there is provided a method for preparing a solid propellant for curing azide-alkyne triazole, characterized in that the method comprises mixing a polymer having alkyne groups at both ends and a compound having azide groups at the ends as a curing agent, followed by curing, wherein the compound having azide groups at the ends is a mixture of a compound represented by the following formula 5 and a compound represented by the following formula 6:

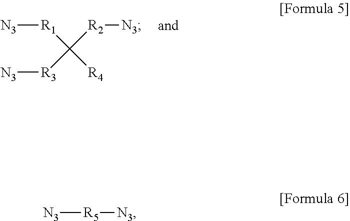

wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

In addition, there is provided a method for preparing a solid propellant for curing azide-alkyne triazole, comprising mixing a polymer with azide groups at both ends and a compound with alkyne groups at the ends as a curing agent, followed by curing.

In addition, there is provided a method for preparing a solid propellant for curing azide-alkyne triazole, comprising mixing a polymer having azide groups at both ends, a compound represented by the following formula 5 having azide groups at the ends as a crosslinking agent, and a compound represented by the following formula 3 having alkyne groups at the ends as a curing agent, followed by curing:

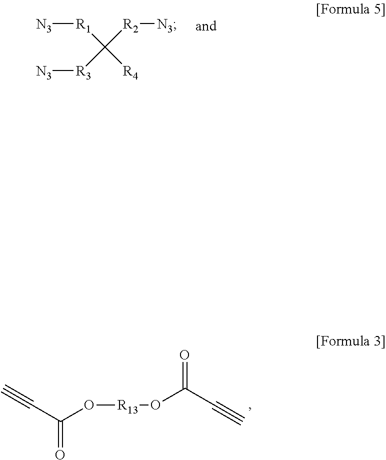

wherein R₁ to R₃ and R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The mixing may be performed at 40 to 60° C.

The curing may be performed at 40 to 70° C.

In addition, there is provided a solid propellant comprising the above-described composition.

According to the present disclosure, the present disclosure comprises a curing agent with a low sensitivity to moisture and is almost unaffected by moisture, thereby requiring no separate dehumidification facility in the process of preparing a propellant.

In addition, according to the present disclosure, the present disclosure does not cause side reactions with external impurities such as moisture (e.g., pores in the propellant due to carbon dioxide generation) such that a propellant with excellent quality can be prepared.

In addition, according to the present disclosure, the present disclosure can prepare a propellant even under a certain level of humidity that suppresses the generation of static electricity, thereby reducing the risk of fire or explosion.

In addition, according to the present disclosure, the present disclosure comprises a catalyst-free reaction that does not use any reaction catalyst and, since it does not use a copper catalyst commonly used in azide-alkyne reactions or any separate solvent, it is environmentally friendly.

In addition, according to the present disclosures, the present disclosure comprises crosslinking a propellant using a triazole group, which has a much higher heat of formation than the urethane group formed in conventional urethane curing systems to increase the energy of the propellant and further activate the combustion reaction of the propellant, thereby increasing the combustion rate of the propellant, and, therefore, less separate propellant combustion catalyst is required to increase the combustion rate of the propellant, as compared to conventional urethane curing systems.

The effects of the present disclosure are not limited thereto and it should be understood that the effects include all effects that can be inferred from the configuration of the present disclosure described in the following specification or claims.

### BRIEF DESCRIPTION OF THE DRAWINGS

FIG. 1 is a schematic diagram of an azide-alkyne triazole curing system according to an embodiment of the present disclosure.

### DETAILED DESCRIPTION OF THE EMBODIMENTS

Hereinafter, preferred embodiments of the present disclosure will be described with reference to accompanying drawings.

The advantages and features of the present disclosure, and methods of achieving them will be clear by referring to the exemplary embodiments that will be described hereafter in detail with reference to the accompanying drawings.

However, the present disclosure is not limited to the exemplary embodiments described hereafter and may be implemented in various ways, and the exemplary embodiments are provided to complete the description of the present disclosure and let those skilled in the art completely know the scope of the present disclosure and the present disclosure is defined by claims.

Further, when it is determined that well-known technologies, etc. may make the scope of the present disclosure unclear, they will not be described in detail in the following description.

Hereinafter, the present disclosure is described in detail.

The present disclosure provides a solid propellant composition for curing azide-alkyne triazole, comprising a polymer having alkyne groups or azide groups at both ends and a compound having azide groups or alkyne groups at two or three ends as a curing agent, wherein the alkyne groups of the polymer react with the compound having azide groups to form a triazole group, and the azide groups of the polymer react with the compound having alkyne groups to form a triazole group.

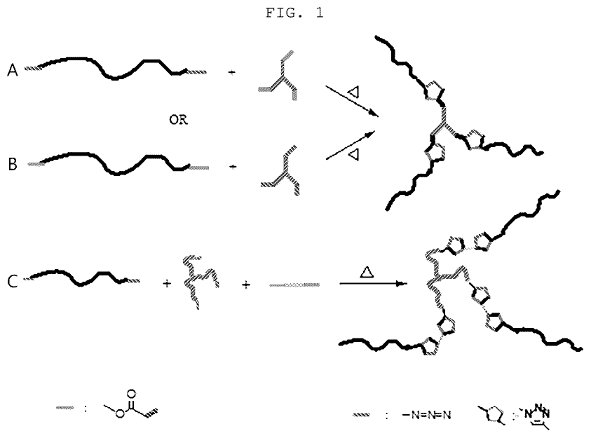

Specifically, the present disclosure provides a solid propellant composition comprising a polymer having alkyne groups at both ends and a compound having azide groups at two or three ends as a curing agent (FIG. 1B), or a solid propellant composition comprising a polymer having azide groups at both ends and a compound having alkyne groups at two or three ends as a curing agent (FIG. 1A). The present disclosure provides a solid propellant composition wherein, when comprising a polymer having azide groups at both ends and a compound having alkyne groups at two or three ends as a curing agent, the composition further comprises a compound having azide groups at three ends as a crosslinking agent (FIG. 1C).

The polymer having alkyne groups at both ends may be represented by the following formula a:

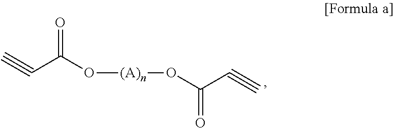

wherein A is an alkylene group having 1 to 20 carbon atoms or an alkenylene group having 2 to 20 carbon atoms, and n is a positive integer.

The polymer having alkyne groups at both ends may be one in which the hydroxyl groups at both ends are substituted with alkyne groups by reacting a polymer having hydroxyl groups at both ends with a compound having a propiolate group at one end and an isocyanate group at the other end.

Here, the polymer having hydroxyl groups at both ends may preferably be hydroxyl-terminated polybutadiene (HTPB), but the present disclosure is not limited thereto. The compound having a propiolate group at one end and an isocyanate group at the other end may be represented by the following formula 4:

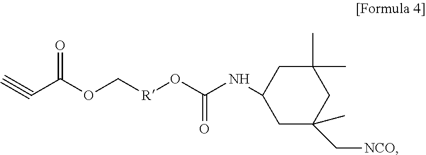

wherein R′ is an alkylene group having 1 to 20 carbon atoms or an alkenylene group having 2 to 20 carbon atoms.

The polymer having azide groups at both ends may be a compound represented by the following formula b, c or d, or a mixture thereof:

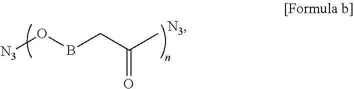

wherein B is an alkylene group having 1 to 20 carbon atoms or an alkenylene group having 2 to 20 carbon atoms, and n is a positive integer;

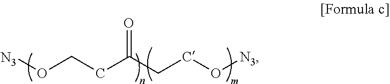

wherein C and C′ are each independently an alkylene group having 1 to 20 carbon atoms or an alkenylene group having 2 to 20 carbon atoms, and m and n are positive integers; and

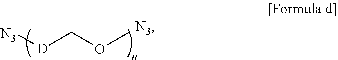

wherein D is an alkylene group having 1 to 20 carbon atoms or an alkenylene group having 2 to 20 carbon atoms, and n is a positive integer. wherein D is an alkylene group having 1 to 20 carbon atoms or an alkenylene group having 2 to 20 carbon atoms, and n is a positive integer.

The polymer having azide groups at both ends may preferably comprise polycaprolactone (PCP) whose ends are modified into an azide group, polycaprolactone ether (PCE) whose ends are modified into an azide group, or polyethylene glycol (PEG) whose ends are modified into an azide group, but the present disclosure is not limited thereto. A method for modifying the ends of the compound into an azide group may comprise a method commonly used in the technical field of the present disclosure.

The compound having azide groups at the ends may be a compound represented by the following formula 5, a compound represented by the following formula 6, or a mixture thereof:

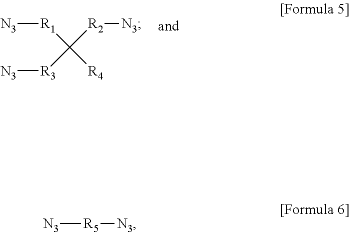

wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The compound having alkyne groups at the ends may be any one or a mixture of two or more of compounds represented by the following formulae 1 to 3:

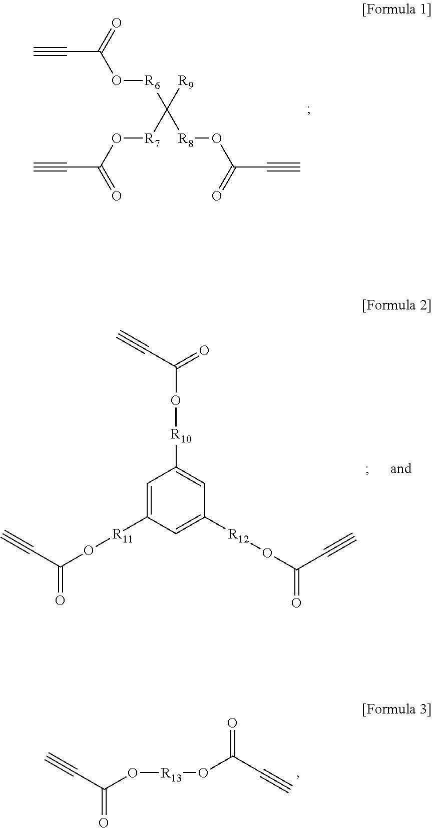

wherein R₆ to R₈, and R₁₀ to R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₉ is an alkyl group having 1 to 20 carbon atoms.

The compound having alkyne groups used in the present disclosure is characterized in that it is a propiolate-based compound having an ester group, an electron-withdrawing group, right next to an alkyne group, as shown in formulae 1 to 4.

The present disclosure relates to a solid propellant composition for curing azide-alkyne triazole, which cures a propellant by forming a polymer network using triazole groups formed by a reaction between an azide compound and an alkyne compound, wherein the alkyne groups at the end of the polymer may react with the azide groups at the ends of the curing agent to form a triazole group, and the azide groups at the ends of the polymer may react with the alkyne groups at the end of the curing agent to form a triazole group.

By using the triazole curing system for curing the propellant by forming a polymer network using triazole groups formed by a reaction between an azide compound and an alkyne compound as described above, the present disclosure is not affected by moisture, thereby requiring no separate dehumidification facility in the process of preparing a propellant, and does not cause side reactions with external impurities such as moisture (e.g., pores in the propellant due to carbon dioxide generation) such that a propellant with excellent quality can be prepared. In addition, the present disclosure can prepare a propellant even under a certain level of humidity that suppresses the generation of static electricity, thereby improving the stability. In addition, the present disclosure has an advantage in that it can adjust the reaction rate by temperature without using a separate solvent and, thus, is environmentally friendly. In addition, the present disclosure comprises crosslinking a propellant using a triazole group, which has a much higher heat of formation than the urethane group formed in conventional urethane curing systems to increase the energy of the propellant and further activate the combustion reaction of the propellant, thereby increasing the combustion rate of the propellant, and, therefore, less separate propellant combustion catalyst is required to increase the combustion rate of the propellant, as compared to conventional urethane curing systems.

The present disclosure provide a solid propellant composition for curing azide-alkyne triazole, comprising a polymer having alkyne groups at both ends and a compound having azide groups at the ends as a curing agent.

The polymer having alkyne groups at both ends may be represented by the following formula a:

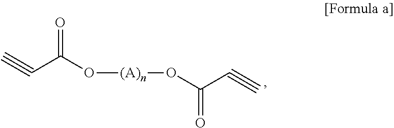

wherein A is an alkylene group having 1 to 20 carbon atoms or an alkenylene group having 2 to 20 carbon atoms, and n is a positive integer.

The polymer having alkyne groups at both ends may be one in which the hydroxyl groups at both ends are substituted with alkyne groups by reacting a polymer having hydroxyl groups at both ends with a compound having a propiolate group at one end and an isocyanate group at the other end.

Here, the polymer having hydroxyl groups at both ends may preferably be hydroxyl-terminated polybutadiene (HTPB), but the present disclosure is not limited thereto.

The compound having azide groups at the ends may be a compound represented by the following formula 5, a compound represented by the following formula 6, or a mixture thereof. In addition, the compound may be a mixture of a compound represented by the following formula 5 and a compound represented by the following formula 6:

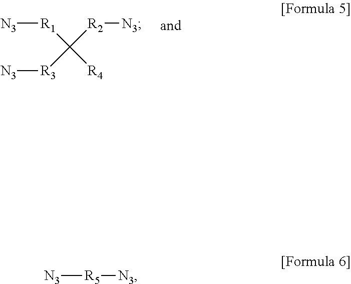

wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The alkyne groups of the polymer may react with the compound having azide groups at two or three ends to form a triazole group. FIG. 1B shows the reaction of a polymer having alkyne groups at both ends and a compound having azide groups at three ends to form a triazole group, and, in addition thereto, a polymer having alkyne groups at both ends may react with a compound having azide groups at two ends, or a polymer having alkyne groups at both ends may react with a mixture of a compound having azide groups at two ends and a compound having azide groups at three ends to form a triazole group.

The present disclosure provides a solid propellant composition for curing azide-alkyne triazole, comprising a polymer having azide groups at both ends and a compound having alkyne groups at the ends as a curing agent.

The polymer having azide groups at both ends may be a compound represented by the following formula b, c or d, or a mixture thereof:

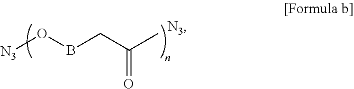

wherein B is an alkylene group having 1 to 20 carbon atoms or an alkenylene group having 2 to 20 carbon atoms, and n is a positive integer;

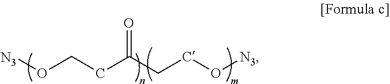

wherein C and C′ are each independently an alkylene group having 1 to 20 carbon atoms or an alkenylene group having 2 to 20 carbon atoms, and m and n are positive integers; or

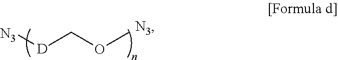

wherein D is an alkylene group having 1 to 20 carbon atoms or an alkenylene group having 2 to 20 carbon atoms, and n is a positive integer. wherein D is an alkylene group having 1 to 20 carbon atoms or an alkenylene group having 2 to 20 carbon atoms, and n is a positive integer.

The polymer having azide groups at both ends may preferably comprise polycaprolactone (PCP) whose ends are modified into an azide group, polycaprolactone ether (PCE) whose ends are modified into an azide group, or polyethylene glycol (PEG) whose ends are modified into an azide group, but the present disclosure is not limited thereto. A method for modifying the ends of the compound into an azide group may comprise a method commonly used in the technical field of the present disclosure.

The compound having alkyne groups at the ends may be any one or a mixture of two or more of compounds represented by the following formulae 1 to 3:

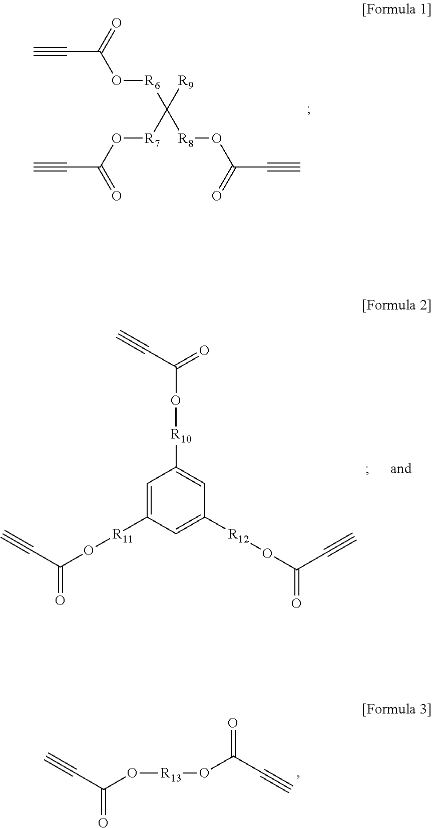

wherein R₆ to R₈, R₁₀ to R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₉ is an alkyl group having 1 to 20 carbon atoms.

The azide groups of the polymer may react with the compound having alkyne groups at two or three ends to form a triazole group. FIG. 1A shows the reaction of a polymer having azide groups at both ends and a compound having alkyne groups at three ends to form a triazole group, and, in addition thereto, a polymer having azide groups at both ends may react with a compound having alkyne groups at two ends, or a polymer having azide groups at both ends may react with a mixture of a compound having alkyne groups at two ends and a compound having alkyne groups at three ends to form a triazole group.

The present disclosure provides a solid propellant composition for curing azide-alkyne triazole, comprising a polymer having azide groups at both ends, a compound having azide groups at three ends as a crosslinking agent, and a compound having alkyne groups at two ends as a curing agent.

The polymer having azide groups at both ends may be a compound represented by the following formula b, c or d, or a mixture thereof:

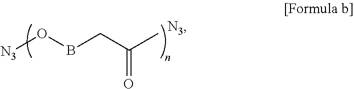

wherein B is an alkylene group having 1 to 20 carbon atoms or an alkenylene group having 2 to 20 carbon atoms, and n is a positive integer;

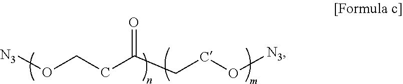

wherein C and C′ are each independently an alkylene group having 1 to 20 carbon atoms or an alkenylene group having 2 to 20 carbon atoms, and m and n are positive integers; and

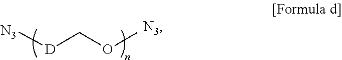

wherein D is an alkylene group having 1 to 20 carbon atoms or an alkenylene group having 2 to 20 carbon atoms, and n is a positive integer. wherein D is an alkylene group having 1 to 20 carbon atoms or an alkenylene group having 2 to 20 carbon atoms, and n is a positive integer.

The polymer having azide groups at both ends may preferably comprise polycaprolactone (PCP) whose ends are modified into an azide group, polycaprolactone ether (PCE) whose ends are modified into an azide group, or polyethylene glycol (PEG) whose ends are modified into an azide group, but the present disclosure is not limited thereto. A method for modifying the ends of the compound into an azide group may comprise a method commonly used in the technical field of the present disclosure.

The compound having azide groups at three ends may be represented by the following formula 5:

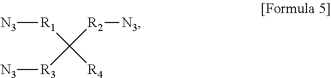

wherein R₁ to R₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The compound having alkyne groups at two ends may be represented by the following formula 3:

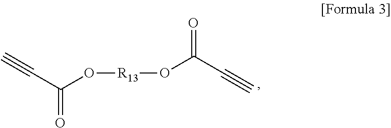

wherein R₁₃ is an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

The azide groups at both ends of the polymer may react with the compound having alkyne groups at two or three ends to form a triazole group. FIG. 1C shows the reaction of a polymer having azide groups at both ends and a compound having alkyne groups at two ends to form a triazole group, and, in addition thereto, a polymer having azide groups at both ends may react with a compound having alkyne groups at three ends, or a polymer having azide groups at both ends may react with a mixture of a compound having alkyne groups at two ends and a compound having alkyne groups at three ends to form a triazole group. In addition, the compound having alkyne groups at two ends may react with the compound having azide groups at three ends to form a triazole group.

The propellant composition of the present disclosure may further comprise an oxidizing agent, a metal powder, a plasticizer, a stabilizer, a binding catalyst, and/or a binder, as follows.

The oxidizing agent may comprise ammonium perchlorate (AP) alone, or, as a nitramine-based oxidizing agent, mixed with any one or a combination of two or more selected from the group consisting of ammonium diniramide (ADN), cyclotrimethylene trinitramine (RDX), cyclotetramethylene tetranitramine (HMX) and hexanitro-hexaaza-tetracyclododecane (HNIW).

The metal powder (fuel) may comprise aluminum (Al). The amount of the metal powder may be 0 to 30% by weight, preferably 1 to 20% by weight, based on the total composition.

The plasticizer may comprise any one or a combination of two or more selected from IDP, BuNENA, BTTN and TMETN. Specifically, a polybutadiene-based propellant may comprise isodecyl pelargonate (IDP), and PCP and PEG-based propellants may comprise butanetriol trinitate (BTTN) and/or trimethylol trinitrate (TMETN). A PCE-based propellant may comprise butyl nitroethyl nitramine (BuNENA).

The stabilizer may comprise methylene-bis-methylbutyl phenol and NMA. Specifically, a polybutadiene-based propellant may comprise methylene-bis-methylbutyl phenol, widely known as AO2246, and a propellant based on PCP, PEG or PCE (i.e., propellants using BuNENA, BTTN or TMETN as a plasticizer) may comprise N-methylaniline (NMA) as a stabilizer.

The curing catalyst may comprise triphenyl bismuth (TPB).

The binder that improves the mechanical properties of the propellant by promoting the bond between the oxidizing particles and the binder may comprise azidated polymeric bonding agent (APBA) represented by the following formula 7, which is a reaction prepart of bis-isophthaloyl-1-methyl-aziridine, tetraethylenepentamine, acrylonitrile and glycidol. Specifically, the polybutadiene-based propellant comprising AP as an oxidizing agent may comprise bis-isophthaloyl-1-methyl-aziridine (HX-752), and the PCE-based propellant may comprise TEPANOL (trade name), which is a reaction prepart of tetraethylenepentamine, acrylonitrile, and glycidol. In addition, the PCP-based propellant and PEG-based propellant comprising, as an oxidizing agent, AP and HNIW, which is a nitramine-based high-energy material, may comprise, as a binder, azidated polymeric bonding agent (APBA), which is a polymer compound having the structure of the following formula 7:

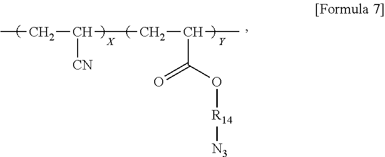

wherein R₁₄ is an alkylene group having 1 to 10 carbon atoms or an alkenylene group having 2 to 10 carbon atoms, Y is a positive number, and X is 1Y to 5Y.

The amount of the compound represented by formula 7 may be 30 to 90% by weight, and preferably 40 to 80% by weight. In addition, the number average molecular weight of the compound represented by formula 7 may be 3000 g/mol to 30,000 g/mol, and preferably 5000 g/mol to 25,000 g/mol.

The present disclosure provides a method for preparing a solid propellant, comprising mixing the solid propellant composition for curing the above-described azide-alkyne triazole, followed by curing.

Specifically, the method comprises mixing a polymer having alkyne groups or azide groups at both ends and a compound having azide groups or alkyne groups at two or three ends as a curing agent, followed by curing. The alkyne groups of the polymer may react with the compound having azide groups to form a triazole group, and the azide groups of the polymer may react with the compound having alkyne groups to form a triazole group.

In addition, the method may comprise mixing a polymer having alkyne groups at both ends and a compound having azide groups at the ends as a curing agent, followed by curing. The compound having azide groups at the ends may comprise the compound of the above-described formula 5, the compound of the above-described formula 6, or a mixture thereof.

In addition, the method may comprise mixing a polymer having azide groups at both ends and a compound having alkyne groups at the ends as a curing agent, followed by curing. The compound having alkyne groups at the ends may be any one or a mixture of two or more selected from the compounds represented by the above-described formulae 1 to 3.

In addition, the method may comprise mixing a polymer having azide groups at both ends, a compound having azide groups at three ends as a crosslinking agent, and a compound having alkyne groups at two ends as a curing agent, followed by curing. The compound having azide groups at three ends may be represented by the above-described formula 5, and the compound having alkyne groups at two ends may be represented by the above-described formula 3.

The polymer having alkyne groups at both ends may be represented by the above-described formula a.

The polymer having azide groups at both ends may be a compound represented by the above-described formula b, c or d, or a mixture thereof.

The mixing may be performed at 40 to 60° C. Specifically, the mixing may be performed under vacuum at 50 to 60° C. before adding an insoluble solid such as an oxidizing agent at the beginning of mixing, and the oxidizing agent may be sequentially added under vacuum at 50 to 60° C., and the sequential addition of the oxidizing agent may be performed in order of particle size, followed by addition of a curing agent and a curing catalyst and mixing to prepare a propellant slurry.

The curing may be performed at 40 to 70° C. for 5 to 10 days. The preparation of a propellant in the temperature range has an advantage in that it has a low viscosity and has excellent charging efficiency, as well as efficiency in a mixing process.

The present disclosure provides a solid propellant comprising the above-described solid propellant composition.

Detailed information about the solid propellant composition overlaps with what is described above and, thus, is omitted.

The solid propellant is not limited as long as it comprises the above-described solid propellant composition, and may follow the preparation process, form, or use commonly used in the technical field of the present disclosure.

### Embodiment

Hereafter, preferred embodiments are proposed to help understand the present disclosure, but the following embodiments just exemplify the present disclosure and the scope of the present disclosure is not limited to the following embodiments.

### Materials

The polymer having alkyne groups at both ends was prepared by reacting hydroxyl-terminated polybutadiene (HTPB) with the PUIMI compound of formula 4-1 to substitute the end of the polybutadiene with an alkyne (Propellants Explos. Pyrotech., 2022, 47, e202200162).

The polymer having azide groups at both ends was prepared by modifying the ends of the polycaprolactone (PCP) (3,000 g/mol, Union Carbide, TONE 0260), polycaprolactone ether (PCE) (2,000 g/mol, Solvay) and polyethylene glycol (PEG) (4,500 g/mol, Dow Chemical) into azide groups (J. Appl. Polym. Sci. (2014), 15: 40594).

Representative compounds used in the following comparative examples and examples (e.g., a curing agent having alkyne groups at the ends, a curing agent having azide groups at the ends, a polymer having alkyne groups at both ends, and a polymer having azide groups at both ends) are shown in Table 1 below.

TABLE 1

| Compound name | Formula | Scheme |
|---|---|---|
| Trimethylolpropane tripropiolate (TMPTP) | Formula 1-1 | 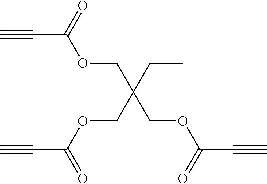 [SMILES: C#CC(=O)OCC(CC)(COC(=O)C#C)COC(=O)C#C] |
| Trimethylolbenzene tripropiolate (TMBTP) | Formula 2-1 | 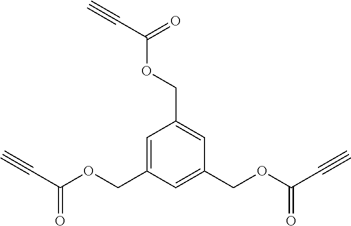 [SMILES: C#CC(=O)OCc1cc(COC(=O)C#C)cc(COC(=O)C#C)c1] |
| Ethylene dipropiolate (EDP) | Formula 3-1 | 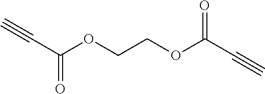 |
| Propiolic urethane isophorone mono-isocyanate (PUIMI) | Formula 4-1 | 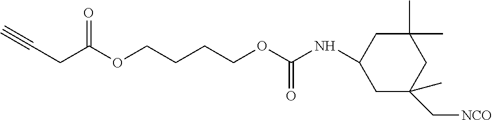 |
| Trimethylolpropane triazide (TMPTA) | Formula 5-1 | 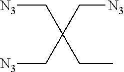 |
| Diazide butane (DAB) | Formula 6-1 | 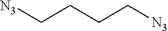 |
| Azidated polymeric bonding agent (APBA) | Formula 7-1 | 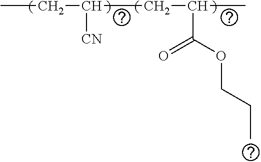 |
| | | (wherein n is a positive integer) |
| Alkyne (propiolate)-terminated polybutadiene (ATPB) | Formula a-1 | 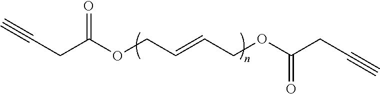 |
| | | (wherein n is a positive integer) |
| Azide-terminated PCP (ATPCP) | Formula b-1 | 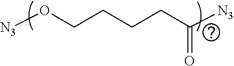 |
| | | (wherein n is a positive integer) |
| Azide-terminated PCE (ATPCE) | Formula c-1 | 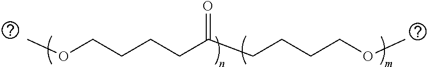 |
| | | (wherein m and n are positive integers) |
| Azide-terminated PEG [symbol] | Formula d-1 [symbol] | 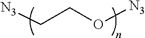 |

[symbol]

indicates data missing or illegible when filed

### Method

The preparation of the propellant of the following comparative examples and examples was performed by mixing the materials using a vertical planetary mixer under vacuum at 50° C., followed by pouring into a mold and curing in an oven at 50° C. for one week.

For the propellant prepared as above, the mechanical properties were tested using a tensile tester, the combustion rate was measured at 500, 1000, 1500, and 2000 psia using a strand burner, and the pressure index was calculated by drawing a combustion rate diagram for each pressure.

### Comparative Example 1

By using a conventional curing system, which is a urethane curing system using isophorone diisocyanate (IPDI) and/or biuret triisocyanate desmodur (N-100), which are isocyanate curing agents, propellants were prepared for each polymer (4 types) with the following composition, followed by comparison of their properties with those of the propellants prepared using the working examples of the present disclosure. The neutral polymeric bonding agent (NPBA) of formula 7-1 wherein the azide groups is a hydroxyl group, as shown in Table 1 above, was used as PCP and PEG-based propellants, to which HNIW, which is a nitline oxidizing agent, is applied.

### Comparative Example 1-1

HTPB 7.449 wt %; AO2246 0.2 wt %; HX-752 0.1 wt %; DOA 3.5 wt %; AP 87 wt %; IPDI 0.651 wt %; TPB 0.1 wt %; ZrC 1.0 wt %.

### Comparative Example 1-2

PCP 9.929 wt %; NPBA 0.4 wt %; NMA 0.5 wt %; BTTN 13.2 wt %; TMETN 3.3 wt %; AP 31 wt %; HNIW 20 wt %; Al 20 wt %; IPDI 1.571 wt %; TPB 0.1 wt %.

### Comparative Example 1-3

PCE 7.442 wt %; BuNENA 13.18 wt %; TEPANOL 0.15 wt %; NMA 0.75 wt %; AP 76.0 wt %; ZrC 1.0 wt %; TPB 0.06 wt %; IPDI 0.607 wt %; N-100 0.871 wt %.

### Comparative Example 1-4

PEG 3.934 wt %; NPBA 0.3 wt %; BTTN 22.2 wt %; TMETN 7.0 wt %; NMA 0.8 wt %; RDX 31.1 wt %; HNIW 30.0 wt %; ZrC 1.7 wt %; TPB 0.1 wt %; N-100 2.866 wt %.

The mechanical properties and combustion properties of the urethane curing propellants of Comparative Examples 1-1 to 1-4 are shown in Table 2.

TABLE 2

| | | Mechanical properties | | | | Combustion properties | |
|---|---|---|---|---|---|---|---|
| Comparative | | Elongation | Tensile | Modulus | Hardness | mm/sec | Pressure |
| Example | Polymer | (%) | (MPa) | (MPa) | (Shore A2) | @6.89 MPa | index |
| Comparative | PB | 21 | 8.9 | 54 | 65 | 11.25 | 0.44 |
| Example | | | | | | | |
| 1-1 | | | | | | | |
| Comparative | PCP | 73 | 7.8 | 22 | 48 | 6.8 | 0.52 |
| Example | | | | | | | |
| 1-2 | | | | | | | |
| Comparative | PCE | 16 | 7.5 | 57 | 69 | 12.43 | 0.31 |
| Example | | | | | | | |
| 1-3 | | | | | | | |
| Comparative | PEG | 80 | 6.3 | 15 | 44 | 12.4 | 0.40 |
| Example | | | | | | | |
| 1-4 | | | | | | | |

### Example 1

Based on the composition of the comparative examples, alkyne-terminated polybutadiene (i.e., alkyne-terminated polybutadiene (ATPB) formed from HTPB and PUIMI) and azide-terminated polymers (i.e., ATPCP, ATPEG and ATPCE) were used respectively as a polymer, and azide compounds or alkyne compounds capable of reacting with functional groups at the ends of the polymer (i.e., propiolate compounds), rather than isocyanate curing agents, were used as a curing agent.

### Example 1-1

HTPB 4.06 wt %; PUIMI 1.07 wt %; AO2246 0.2 wt %; HX-752 0.1 wt %; DOA 7.3 wt %; AP 86 wt %; TMPTA 0.178 wt %; TPB 0.1 wt %; ZrC 1.0 wt %.

### Example 1-2

ATPCP 10.863 wt %; APBA 0.4 wt %; NMA 0.5 wt %; BTTN 13.2 wt %; TMETN 3.3 wt %; AP 31 wt %; HNIW 20 wt %; Al 20 wt %; TMPTP 0.737 wt %.

### Example 1-3

ATPCE 7.646 wt %; BuNENA 13.65 wt %; TEPANOL 0.15 wt %; NMA 0.75 wt %; AP 76.0 wt %; ZrC 1.0 wt %; EDP 0.342 wt %; TMBTP 0.462 wt %.

### Example 1-4

ATPEG 6.506 wt %; APBA 0.3 wt %; BTTN 22.2 wt %; TMETN 7.0 wt %; NMA 0.8 wt %; RDX 31.1 wt %; HNIW 30.0 wt %; ZrC 1.7 wt %; TMPTP 0.394 wt %.

The mechanical properties and combustion properties of the triazole curing propellants of Examples 1-1 to 1-4 are shown in Table 3.

TABLE 3

| | | Mechanical properties | | | | Combustion properties | |
|---|---|---|---|---|---|---|---|
| | | Elongation | Tensile | Modulus | Hardness | mm/sec | Pressure |
| Example | Polymer | (%) | (MPa) | (MPa) | (Shore A2) | @6.89 MPa | index |
| Example | HTPB | 17 | 3 | 70 | 69 | 9.6 | 0.28 |
| 1-1 | | | | | | | |
| Example | ATPCP | 58 | 11.3 | 47 | 66 | 8.0 | 0.48 |
| 1-2 | | | | | | | |
| Example | ATPCE | 48 | 8.3 | 28 | 61 | 13.54 | 0.29 |
| 1-3 | | | | | | | |
| Example | ATPEG | 36 | 6.0 | 25 | 49 | 13.6 | 0.42 |
| 1-4 | | | | | | | |

Referring to Table 3, the solid propellants prepared by the triazole curing system according to the present disclosure (Examples 1-1 to 1-4) showed very excellent mechanical properties, which is comparable to the mechanical properties of solid propellants prepared by conventional urethane curing systems (Comparative Examples 1-1 to 1-4).

In particular, the PCE-based propellant (Comparative Example 1-3) prepared by conventional urethane curing had a disadvantage in that it has a low elongation value. Such a disadvantage of the PCE-based propellant was significantly overcome by using triazole curing according to the present disclosure, resulting in excellent elongation and tensile strength.

With regard to the combustion properties, the combustion rate of propellants prepared under the triazole curing system according to the present disclosure was more than 10% faster than that of the propellants prepared using the urethane curing system, and there was little effect on the pressure index.

The PB-based propellants prepared by the triazole curing system showed a lower combustion rate than that of the propellants prepared by the urethane curing system, but showed a pressure index and a rate of change in the combustion rate according to pressure, which were significantly low.

Embodiments about a solid propellant composition for curing azide-alkyne triazole and a method for preparing a solid propellant for curing azide-alkyne triazole using same according to the present disclosure were described above, but it is apparent that various modifications may be achieved without departing from the scope of the present disclosure.

Therefore, the scope of the present disclosure should not be limited to the embodiment(s) and should be determined by not only the following claims, but equivalents of the claims.

That is, it should be understood that the embodiments described above are not limitative, but only examples in all respects, the scope of the present disclosure is expressed by claims described below, not the detailed description, and it should be construed that all of changes and modifications achieved from the meanings and scope of claims and equivalent concept are included in the scope of the present disclosure.

What is claimed is:

1. A solid propellant composition comprising:
a polymer having alkyne groups or azide groups at both ends; and
a compound having azide groups or alkyne groups at two or three ends as a curing agent,
wherein the alkyne groups of the polymer react with the compound having azide groups to form a triazole group, and the azide groups of the polymer react with the compound having alkyne groups to form a triazole group.

2. The solid propellant composition of claim 1,
wherein the composition comprises a polymer having alkyne groups at both ends and a compound having azide groups at the ends as a curing agent,
wherein the compound having azide groups at the ends is a mixture of a compound represented by the following formula 5 and a compound represented by the following formula 6: 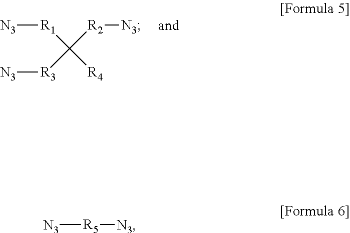
wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

3. The solid propellant composition of claim 1,
wherein the composition comprises a polymer having azide groups at both ends and a compound having alkyne groups at the ends as a curing agent.

4. The solid propellant composition of claim 3,
wherein the compound having alkyne groups at the ends is any one or a mixture of two or more selected from compounds represented by the following formulae 1 to 3: 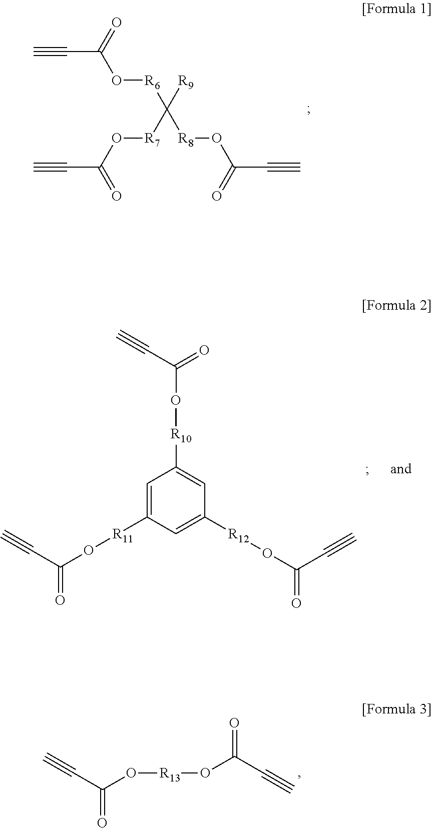
wherein R₆ to R₈, and R₁₀ to R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₉ is an alkyl group having 1 to 20 carbon atoms.

5. The solid propellant composition of claim 1,
wherein the composition comprises a polymer having azide groups at both ends, a compound represented by the following formula 5 having azide groups at the ends as a crosslinking agent, and a compound represented by the following formula 3 having alkyne groups at the ends as a curing agent: 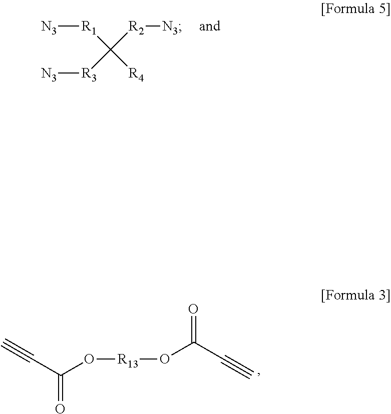
wherein R₁ to R₃ and R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

6. The solid propellant composition of claim 1,
wherein the polymer having alkyne groups at both ends is represented by the following formula a: 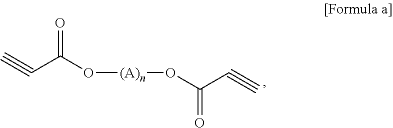
wherein A is an alkylene group having 1 to 20 carbon atoms or an alkenylene group having 2 to 20 carbon atoms, and n is a positive integer.

7. The solid propellant composition of claim 1,
wherein the polymer having alkyne groups at both ends is prepared by reacting a polymer having hydroxyl groups at both ends with a compound having a propiolate group at one end and an isocyanate group at the other end, so that the hydroxyl groups at both ends are substituted with alkyne groups.

8. The solid propellant composition of claim 1,
wherein the polymer having azide groups at both ends is one or a mixture of two or more selected from compounds represented by the following formulae b, c and d: 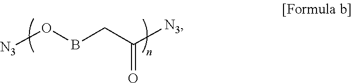
wherein B is an alkylene group having 1 to 20 carbon atoms or an alkenylene group having 2 to 20 carbon atoms, and n is a positive integer; 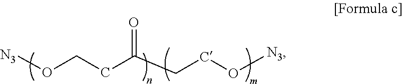
wherein C and C′ are each independently an alkylene group having 1 to 20 carbon atoms or an alkenylene group having 2 to 20 carbon atoms, and m and n are positive integers; and 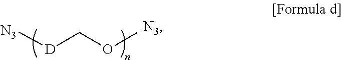
wherein D is an alkylene group having 1 to 20 carbon atoms or an alkenylene group having 2 to 20 carbon atoms, and n is a positive integer.

9. The solid propellant composition of claim 1,
wherein the polymer having azide groups at both ends is any one or a mixture of two or more selected form the group consisting of polycaprolactone, polyethylene glycol, and polycaprolactone ether whose both ends are substituted into azide groups.

10. The solid propellant composition of claim 1,
wherein the composition comprises ammonium perchlorate (AP) alone or mixed with any one or a combination of two or more selected from the group consisting of ammonium diniramide (ADN), cyclotrimethylene trinitramine (RDX), cyclotetramethylene tetranitramine (HMX) and hexanitro-hexaaza-tetracyclododecane (HNIW) as an oxidizing agent.

11. The solid propellant composition of claim 1,
wherein the composition comprises aluminum (Al) as a metal fuel.

12. The solid propellant composition of claim 1,
wherein the composition comprises any one or a combination of two or more selected from the group consisting of Isodecyl pelargonate (IDP), butyl nitroethyl nitramine (BuNENA), butanetriol trinitate (BTTN) and trimethylol trinitrate (TMETN) as a plasticizer.

13. The solid propellant composition of claim 1,
wherein the composition comprises a compound represented by the following formula 7 as a binding agent: 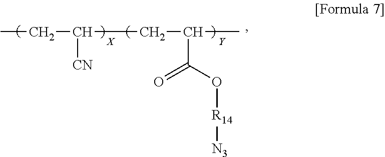
wherein R₁₄ is an alkylene group having 1 to 10 carbon atoms or an alkenylene group having 2 to 10 carbon atoms, Y is a positive number, and X is 1Y to 5Y.

14. A method for preparing a solid propellant comprising:
mixing a polymer having alkyne groups or azide groups at both ends and a compound having azide groups or alkyne groups at two or three ends as a curing agent, followed by curing,
wherein the alkyne groups of the polymer react with the compound having azide groups to form a triazole group, and the azide groups of the polymer react with the compound having alkyne groups to form a triazole group.

15. The method for preparing a solid propellant of claim 14,
wherein the method comprises mixing a polymer having alkyne groups at both ends and a compound having azide groups at the ends as a curing agent, followed by curing,
wherein the compound having azide groups at the ends is a mixture of a compound represented by the following formula 5 and a compound represented by the following formula 6: 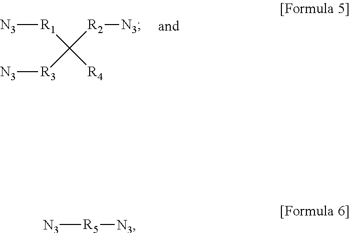
wherein R₁ to R₃ and R₅ are each independently selected from an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

16. The method for preparing a solid propellant of claim 14,
wherein the method comprises mixing a polymer with azide groups at both ends and a compound with alkyne groups at the ends as a curing agent, followed by curing.

17. The method for preparing a solid propellant of claim 14,
wherein the method comprises mixing a polymer having azide groups at both ends, a compound represented by the following formula 5 having azide groups at the ends as a crosslinking agent, and a compound represented by the following formula 3 having alkyne groups at the ends as a curing agent, followed by curing: 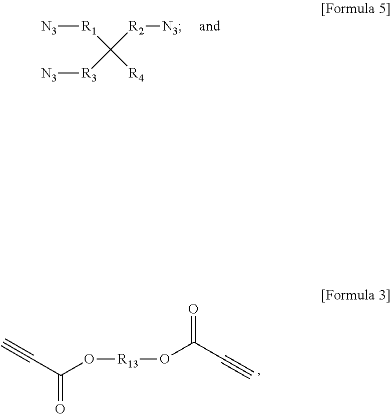
wherein R₁ to R₃ and R₁₃ are each independently an alkylene group having 1 to 20 carbon atoms, an alkenylene group having 2 to 20 carbon atoms, a cycloalkylene group having 3 to 20 carbon atoms, an arylene group having 6 to 20 carbon atoms, or —R—O—R— (in which R is an alkylene group having 1 to 20 carbon atoms or an alkenylene group having 2 to 20 carbon atoms), and R₄ is an alkyl group having 1 to 20 carbon atoms.

18. The method for preparing a solid propellant of claim 14,
wherein the mixing is performed at 40 to 60° C.

19. The method for preparing a solid propellant of claim 14,
wherein the curing is performed at 40 to 70° C.

20. A solid propellant comprising the composition of claim 1.
